(19) United States
(12) Patent Application Publication
(10) Pub. No.: US 2014/0350852 A1
(43) Pub. Date: Nov. 27, 2014

(54) DEVICE AND METHOD FOR DETECTING OBJECTS IN A STREAM OF SENSOR DATA

(71) Applicants: Stefan Nordbruch, Kortwestheim (DE); Thomas Kropf, Reutlingen (DE)

(72) Inventors: Stefan Nordbruch, Kortwestheim (DE); Thomas Kropf, Reutlingen (DE)

(21) Appl. No.: 14/353,209

(22) PCT Filed: Aug. 28, 2012
(86) PCT No.: PCT/EP2012/066647

§ 371 Date: Aug. 5, 2014

(30) Foreign Application Priority Data
Oct. 24, 2011 (DE) 10 2011 085 060.0

(51) Int. Cl. G06T 7/00; G06K 9/00; G06T 1/00

(52) U.S. Cl. CPC G06T 7/004; G06T 1/0007; G06K 9/00791; G06T 2207/10016
USPC 701/523

(57) ABSTRACT

A device for detecting objects in a stream of sensor image data corresponding to images of vehicle surroundings detected by a surroundings sensor of a vehicle includes:
a position determination unit for determining a vehicle position,
an ascertainment unit for ascertaining which object is situated in the direction of travel according to the determined vehicle position on a route of the vehicle, and
a filter for filtering the sensor image data according to a location of the ascertained object in order to detect the object in the sensor image data.

### BACKGROUND OF THE INVENTION

1. Field of the Invention

The present invention relates to a device and a method for detecting objects in a stream of sensor data. The present invention furthermore relates to a corresponding system for detecting objects in a stream of sensor data and a vehicle system. The present invention furthermore relates to a computer program.

2. Description of the Related Art

U.S. Patent Application Publication US 2007/0154067 A1 describes an image analysis method for identifying traffic signs in images. The result of the analysis, i.e., the identified traffic signs along with an associated position, is written into a database.

### BRIEF SUMMARY OF THE INVENTION

An object of the present invention is providing an improved device and an improved method for detecting objects in a stream of sensor data.

An object of the present invention is providing a corresponding system for detecting objects in a stream of sensor data.

An object of the present invention is providing a corresponding vehicle system.

In addition, an object of the present invention is providing a corresponding computer program.

According to one aspect, a device is provided for detecting objects in a stream of sensor data. Here, the sensor data are formed with the aid of a surroundings sensor of a vehicle and correspond to vehicle surroundings which are sensor-detected with the aid of the surroundings sensor.

The device includes a position determination unit for determining a vehicle position. Furthermore, an ascertainment unit is provided which is able to ascertain which object is situated in the direction of travel according to the determined vehicle position of the vehicle on a route of the vehicle. In addition, the device includes a filter for filtering the sensor data according to the ascertained object in order to detect the object in the sensor data.

According to another aspect, a method is provided for detecting objects in a stream of sensor data. The sensor data are formed with the aid of a surroundings sensor of a vehicle and correspond to vehicle surroundings which are sensor-detected with the aid of the surroundings sensor. Furthermore, a vehicle position is determined. In addition, it is ascertained which object is situated in the direction of travel according to the determined vehicle position of the vehicle on a route of the vehicle. The sensor data are then filtered according to the ascertained object in order to detect the object in the sensor data.

According to another aspect, a system is provided for detecting objects in a stream of sensor data. The sensor data are formed with the aid of a surroundings sensor of a vehicle and correspond to vehicle surroundings which are sensor-detected with the aid of the surroundings sensor. The system includes the device for detecting objects in a stream of sensor data and a server which includes a database. Object data including associated position data are stored in the database, the object data corresponding to objects.

According to yet another aspect, a vehicle system is provided which includes a surroundings sensor for carrying out sensor-based detection of vehicle surroundings and the device for detecting objects in a stream of sensor data or the system for detecting objects in a stream of sensor data.

According to yet an additional aspect, a computer program is provided which includes program code for carrying out the method for detecting objects in a stream of sensor data, when the computer program is run on a computer.

The present invention thus in particular includes the idea of carrying out sensor-based detection of vehicle surroundings with the aid of a surroundings sensor and forming corresponding sensor data. Since the sensor-based detection is generally carried out on a continuing or continuous basis, a stream of sensor data is formed in this respect. A vehicle position is determined. In particular, a navigation system may be provided for determining the vehicle position. A global positioning system (GPS) sensor is preferably provided for determining the vehicle position.

It is subsequently ascertained which object on a route of the vehicle is situated in the direction of travel according to the determined vehicle position. It thus means in particular that it is ascertained what kind of object or what type of object is situated in the direction of travel according to the determined vehicle position. It thus means in particular that after the ascertainment is made, it is known which object will appear in the direction of travel according to the determined vehicle position, or the object toward which the vehicle is moving in the direction of travel is known. In particular, it may be provided that it is ascertained which object is spatially nearest with respect to the determined vehicle position in the direction of travel of the vehicle. It may preferably be ascertained which objects, in particular the spatially nearest objects, are situated relative to the determined vehicle position in the direction of travel. Based on the ascertained object, in particular on the knowledge of what kind of object it is, the sensor data are then filtered accordingly in order to detect or identify the object in the sensor data.

Since, after the ascertainment has been made, it is known which object is located in the direction of travel according to the determined vehicle position, it is possible to carry out filtering of the sensor data much more efficiently and with a considerably higher hit rate compared to the related art, in order to detect or identify the object in the sensor data. In this respect, the corresponding object detection is advantageously pre-parameterized, provided it is known which object must be searched for in the sensor data. The corresponding object detection analysis is thus triggered via known data, corresponding here to the ascertained object.

Sensor data in the context of the present invention include in particular information about the vehicle surroundings. Such information may, for example, relate to physical objects. A physical object, may, for example, be a traffic sign, a signaling system, or a boundary post of the road. The sensor data in particular include physical features or characteristics of the road such as, for example, a road width, a lane width, curve radii, and/or exit ramps. The sensor data generally include dimensions and/or positions of the physical objects, in particular of the relative positions to each other. It thus means, for example, that a width, a height, and/or a length of the physical object is/are detected. In particular, the respective position and dimensions are also stored in the sensor data for stationary physical objects. Sensor data may in particular also include information about present situations such as, for example, that a construction site having altered road characteristics is present at the corresponding position. Sensor data may in particular also include lane information which, for example, includes information about a lane line color. Sensor data in the context of the present invention include in particular images and/or videos. A corresponding position is in particular associated with the sensor data. A vehicle position is advantageously determined at the point in time of the sensor-based detection of the vehicle surroundings, so that the determined vehicle position may be associated with the determined vehicle surroundings and thus with the corresponding sensor data.

The core of the present invention is thus in particular that the physical objects are searched for in the sensor data. In particular, a detection analysis is thus carried out with respect to the physical objects in the sensor data, so that identified objects may be advantageously classified. It thus means in particular that an identified object may be classified, for example, as a traffic sign, a signaling system, an information sign, a boundary post, a construction site, a bridge, an infrastructure, a building, a tree, or a railroad crossing barrier.

According to one specific embodiment, the surroundings sensor may be a video sensor, a radar sensor, an ultrasound sensor, or a lidar sensor. The surroundings sensor may be included in a surroundings sensor system for carrying out sensor-based detection of the vehicle surroundings. The surroundings sensor system may have additional surroundings sensors which preferably may be formed identically or differently. In particular, the surroundings sensor system may include a video camera, preferably a 3D video camera, a surroundings camera system for the pictorial detection of 360° surroundings of the vehicle, a time-of-flight sensor, and/or a photonic mixing device (PMD) sensor. A PMD sensor may in particular be used as an image sensor in a TOF (time-of-flight) camera, which is based on light time-of-flight methods. The video camera may in particular be a stereo video camera. It may preferably be provided that the sensor data of each sensor are consolidated so that objects are searched for and then classified in the consolidated sensor data.

According to one specific embodiment, the ascertainment unit includes a querying unit for querying a database based on the determined vehicle position. Object data which correspond to objects are stored in the database, position data being associated with the object data. It thus means in particular that the database is queried, the inquiry in particular being carried out based on the determined vehicle position. It thus means in particular that the vehicle position is transmitted to the database so that the database may then accordingly return object data, the returned object data corresponding to objects or an object which are/is situated in the direction of travel according to the determined vehicle position on the route. The database is queried in this respect as to which object is situated in the direction of travel according to the determined vehicle position. In particular, it is queried what the nearest object is relative to the determined vehicle position. The database then responds accordingly and returns the data to the querying unit.

In another specific embodiment, it may be provided that the querying unit is configured to transmit the sensor data corresponding to the detected object to the database. It thus means in particular that the sensor data corresponding to the detected object are transmitted to the database. This makes it possible, for example, to update the database in an advantageous manner. The database is thus updated accordingly, in particular after the detection analysis is carried out.

According to one specific embodiment, the database is situated externally from the vehicle. “Externally” refers in particular to an area outside the vehicle.

In another specific embodiment, it may be provided that the database is situated internally within the vehicle. “Internally” refers in particular to an area in and/or on the vehicle.

According to another specific embodiment, it may be provided that communication between the ascertainment unit and the external database or an external server including the external database is carried out, for example, with the aid of a C2I method. Here, the abbreviation “C2I” stands for “car to infrastructure.” A C2I communication method in this respect refers to a communication method from a vehicle to an infrastructure or to a physical object which is not a vehicle, such as a signaling system or a base station. Communication may preferably also be carried out with the aid of a mobile radio communication method. In particular, such a mobile radio communication method may be the “long-term evolution” (LTE) communication method.

In one additional specific embodiment, it may be provided that communication between the ascertainment unit and the database or the server including the database is carried out using wireless communication methods, regardless of whether it is an internal or external database. For example, the WLAN communication method and/or Bluetooth may be used for communication between the ascertainment unit and the database.

In one additional specific embodiment, in the case of an internal database, it may be provided that this database is updated with the aid of a storage medium, in particular a CD-ROM or a USB stick on which the corresponding object data are stored.

In one additional specific embodiment, multiple databases may also be provided. It thus means in particular that multiple databases may be queried in order to ascertain which object is situated in the direction of travel according to the vehicle position on the route. The multiple databases may in particular be formed as internal or external databases. Preferably, both internal and external databases may be formed. Redundancy is thus advantageously achieved, since at least one additional database is still available for the purpose of inquiry in the event of a database failure.

According to another specific embodiment, a time determination unit is provided for determining a point in time at which the ascertained object is detectable with the aid of the surroundings sensor, the filter being configured to filter the sensor data according to the point in time. It thus means in particular that a point in time is determined at which the ascertained object is detectable with the aid of the surroundings sensor, the sensor data being filtered according to the point in time. It is thus in particular detected when the object will reach the sensor range, so that the object may be detected with the aid of the sensor. For example, if it has been ascertained that the object is located at a distance of, for example, three kilometers relative to the determined vehicle position, it is then possible to calculate when the object will reach the sensor range based on the vehicle speed. In particular, the sensor range is known for this purpose. More efficient and effective filtering of the sensor data may thus be achieved given that it is now known when the object will come. It is thus advantageously no longer necessary to search for the object in sensor data in which the object may not be present at all, since it is not yet at all detectable with the aid of the surroundings sensor. Corresponding computing effort is thus advantageously reduced considerably.

In another specific embodiment, another position determination unit for determining a relative position of the ascertained object with respect to the surroundings sensor may be provided, the filter being configured to determine the sensor data corresponding to the relative position. It thus means in particular that a relative position of the ascertained object is determined with respect to the surroundings sensor. In particular, the sensor data are filtered according to the relative position. It is thus determined, for example, whether the object is located above, below, on the left, or on the right, relative to the surroundings sensor. “Relative to the surroundings sensor” means in particular relative to a sensor axis. Therefore, filtering of the sensor data may advantageously be carried out particularly efficiently and effectively given that it is known where the object will be located. For example, the object may be located above and on the right relative to the surroundings sensor. The object is thus located in an upper right area in a corresponding sensor image which may be formed with the aid of the sensor data. A corresponding search for the object may in this respect concentrate advantageously only on this upper right area. It is no longer necessary to search for the object in the other areas of the sensor image, i.e., in the corresponding sensor data. Therefore, corresponding computing effort may advantageously be reduced considerably.

According to another specific embodiment, it may be provided that the objects which are situated on the route transmit both their position and preferably also their corresponding object type themselves; in particular, they transmit this information to the ascertainment unit, so that the ascertainment unit advantageously becomes aware of which objects are located on the route and where they are located.

According to another specific embodiment, it may be provided that the filtering of the sensor data is carried out externally from the vehicle. It thus means in particular that the computation with respect to the object detection is carried out externally. A corresponding result may then be communicated to the vehicle or transmitted to the vehicle. Thus, by carrying out the computation externally, it is not necessary for the vehicle to have a computer which is designed to have a correspondingly high level of power. Communication between the vehicle and a corresponding external computer or server may be carried out in particular with the aid of one of the above-described communication methods. Internal computation may preferably be carried out with respect to the object detection in the vehicle. A combination of internal and external computation may preferably be provided. It thus means in particular that filtering is carried out both internally and externally. In particular, corresponding results may thus advantageously be compared with each other, so that possible errors may be identified in the event of a deviation, so that, for example, a repeated computation may be carried out.

### BRIEF DESCRIPTION OF THE DRAWINGS

FIG. 1 shows a device for detecting objects in a stream of sensor data.

FIG. 2 shows a flow chart of a method for detecting objects in a stream of sensor data.

FIG. 3 shows a system for detecting objects in a stream of sensor data.

FIG. 4 shows a vehicle system.

FIG. 5 shows two sensor images.

FIG. 6 shows multiple sensor images.

FIG. 7 shows two sensor images.

### DETAILED DESCRIPTION OF THE INVENTION

Identical reference numerals are used below to label identical features.

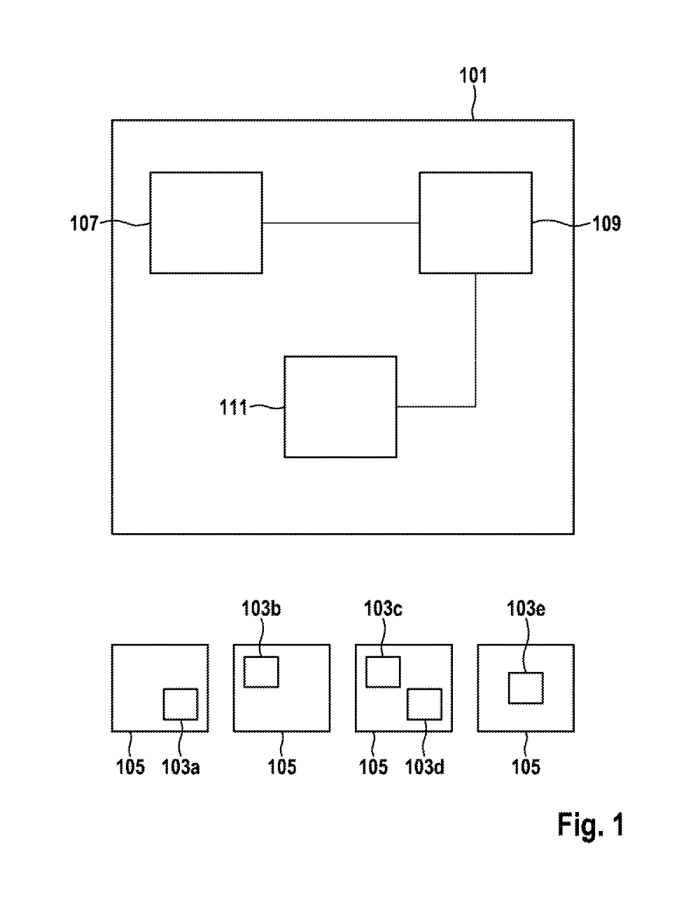

FIG. 1 shows a device 101 for detecting objects 103a, 103b, 103c, 103d, and 103e in a stream, in particular, a chronological stream, of sensor data 105. Here, sensor data 105 are formed with the aid of a surroundings sensor, which is not shown, of a vehicle, which is not shown, and correspond to vehicle surroundings which are sensor-detected with the aid of the surroundings sensor.

Device 101 furthermore includes a position determination unit 107, with the aid of which a vehicle position may be determined. In addition, device 101 includes an ascertainment unit 109 which is able to ascertain which object is situated in the direction of travel according to the determined vehicle position on a route of the vehicle. Furthermore, a filter 111 is formed which filters sensor data 105 according to the ascertained object in order to detect the object in sensor data 105.

It thus means in particular that ascertainment unit 109 ascertains exactly which objects or what kinds of objects are in sensor data 105. Since it is known which objects are included in the sensor data, it is possible to carry out corresponding filtering more efficiently and effectively. In particular, corresponding filtering may be carried out considerably more rapidly.

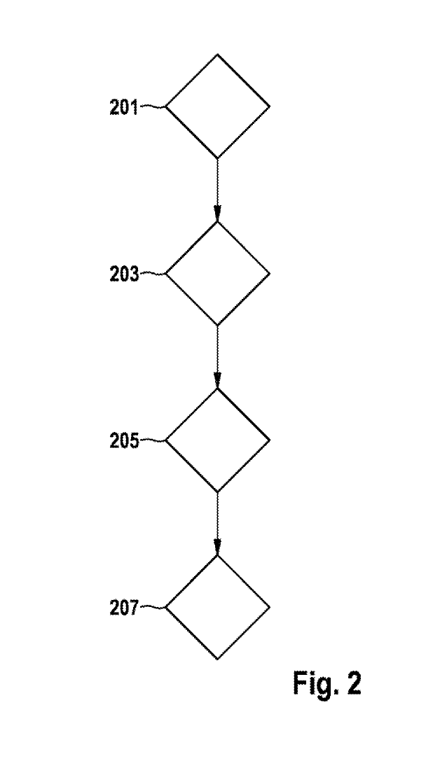

FIG. 2 shows a flow chart of a method for detecting objects in a stream of sensor data. According to a step 201, the sensor data are formed with the aid of a surroundings sensor of a vehicle and correspond to vehicle surroundings which are sensor-detected with the aid of the surroundings sensor. In a step 203, a vehicle position is determined. According to a step 205, it is ascertained which object is situated in the direction of travel according to the determined vehicle position on a route of the vehicle. In a step 207, the sensor data are filtered according to the ascertained object in order to detect the object in the sensor data.

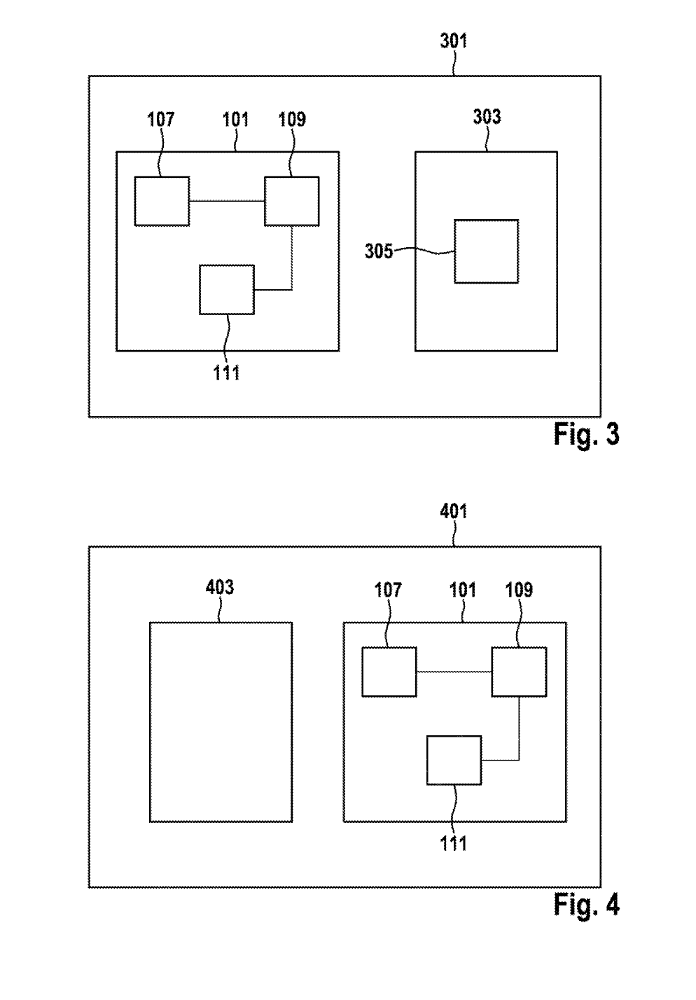

FIG. 3 shows a system 301 for detecting objects in a stream of sensor data. System 301 includes device 101 according to FIG. 1. Furthermore, system 301 includes a server 303 having a database 305. Object data are stored in database 305 which correspond to objects. Furthermore, position data are associated with the object data. Device 101 may in this respect advantageously query database 305 based on the determined vehicle position in order to become aware of which object comes next in the direction of travel according to the determined vehicle position. In this respect, device 101 poses in particular a corresponding query to database 305.

FIG. 4 shows a vehicle system 401. Vehicle system 401 includes a surroundings sensor 403 and device 101 according to FIG. 1. In a specific embodiment which is not shown, it may be provided that vehicle system 401 includes system 301 according to FIG. 3 instead of device 101.

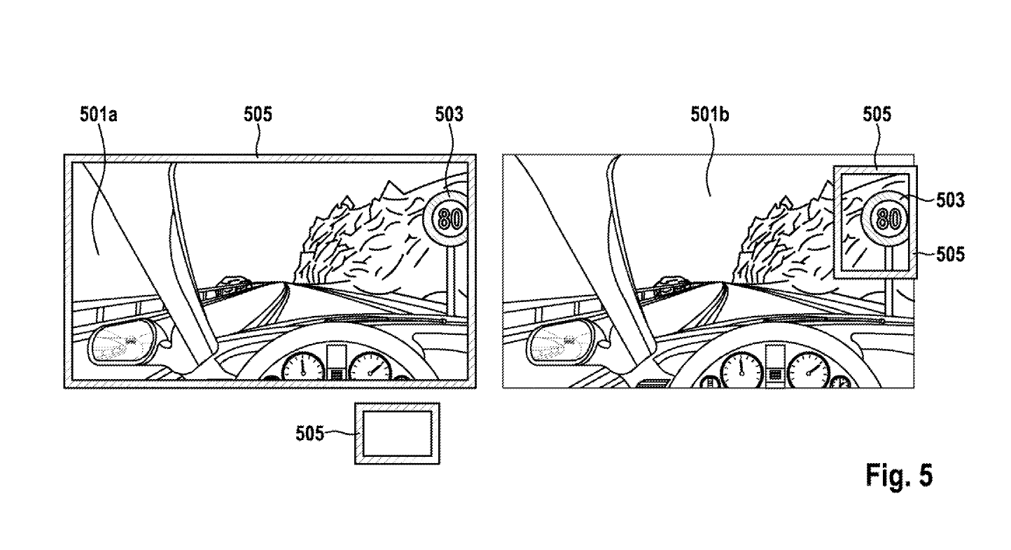

FIG. 5 shows two sensor images 501a and 501b. Here, sensor images 501a and 501b correspond to a video image which has been recorded with the aid of a video camera through a windshield of a vehicle. A traffic sign 503 may be seen in a right upper area in sensor images 501a and 501b which displays that the maximum permitted speed on this section of road is 80 km per hour.

According to the left sensor image 501a, a search area 505 for detecting traffic sign 503 includes the entire sensor image 501a. It thus means in particular that it is necessary to search for traffic sign 503 in all of the sensor data which form sensor image 501a. Corresponding computing effort is considerable. Furthermore, such computation is also very time-consuming. However, it is generally necessary to extend search area 505 to the entire sensor image 501 since there is no specific information relating to traffic sign 503 or generally relating to the physical objects to be identified. It thus means in particular that it is not known what the next object is, when the next object will come, and where the next object will be located.

This information, i.e., what the next object is and in particular when the next object will come and preferably where the next object will be located, may, for example, be queried from a database. If this information is known, it being able to be provided in particular that it is already sufficient that it is known only what the next object is, search area 505 may be reduced. This is shown in right sensor image 501b. It is therefore not necessary to search the corresponding sensor data completely which form sensor image 501b. It is sufficient to search only a small portion of the sensor data. In this respect, corresponding computing effort is advantageously reduced considerably in comparison to right sensor image 501a and may be carried out considerably more rapidly.

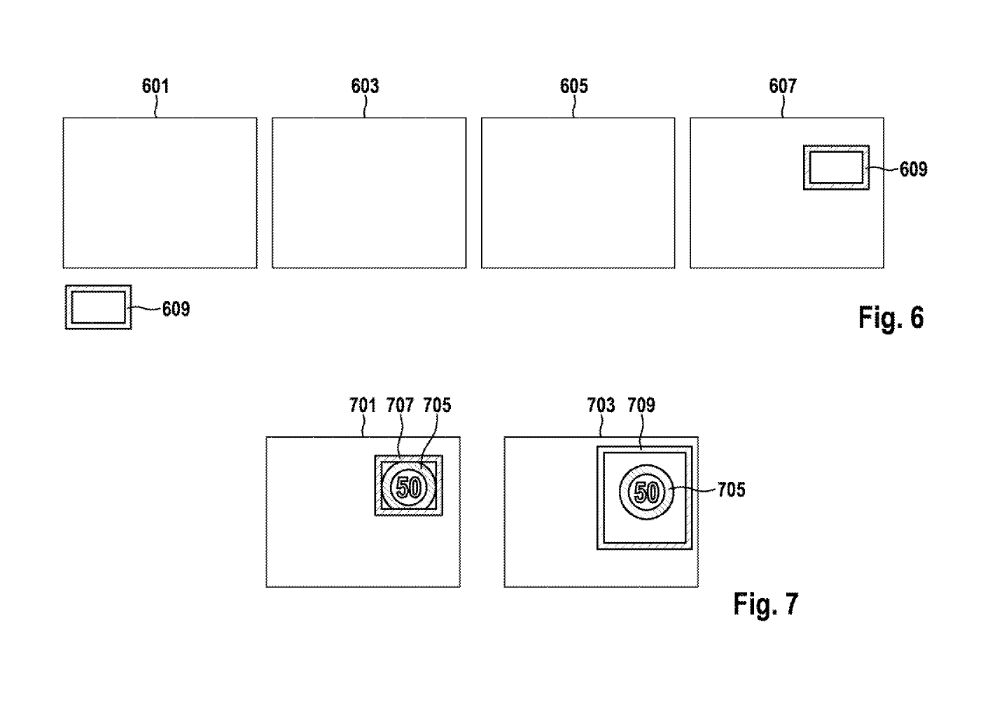

FIG. 6 schematically shows multiple sensor images 601, 603, 605, 607 which are recorded chronologically in succession. Since it is known with the aid of a database query what the next object is, when the next object will come, and where the next object will be located, it possibly being sufficient in particular merely to know what the next object is, a corresponding search area 609 may be reduced. In particular, if it is known when the next object will come, it may merely be provided to search sensor image 607 corresponding to search area 609. It is not necessary to search chronologically preceding sensor images 601, 603, and 605, since it may be ruled out here that the object searched for is present in these sensor images.

FIG. 7 shows two additional sensor images 701 and 703. A traffic sign to be detected or to be identified is symbolically labeled here using reference numeral 705. Traffic sign 705 is a traffic sign which displays that a maximum permitted speed on the section of road is 50 km/h. A corresponding search area for sensor image 701 is labeled using reference numeral 707. A corresponding search area for sensor image 703 is labeled using reference numeral 709.

As FIG. 7 clearly shows, search area 709 is larger than search area 707. It thus means in particular that a larger area is searched in sensor image 703 compared to sensor image 701 in order to detect traffic sign 705 in the corresponding sensor data.

By making a search area larger, a safety buffer is advantageously created in this respect which in particular is able to take inaccuracies into account. Such inaccuracies may, for example, be inaccurate sensor data which result from insufficient quality of a sensor. In this respect in particular, it is therefore also advantageously possible to take sensor quality into account with corresponding filtering. It means in particular that for a sensor having a low quality factor which thus in particular provides sensor data having lower quality, the search area is automatically enlarged in comparison to a sensor having a high quality factor which thus in particular provides sensor data having high quality.

In one additional specific embodiment which is not shown, it may be provided that characteristic features of the physical objects are stored in the database which may advantageously facilitate an analysis of the search area for the object. For example, such characteristic features may be a color and/or a size of the object.

In one additional specific embodiment which is not shown, additional data about the objects is stored in the database which may advantageously facilitate an analysis of the search area for the object. These additional data may, for example, include information indicating that the object is dirty or that the object is partially destroyed.

In another specific embodiment which is not shown, quality information is integrated into the database for the objects and the corresponding object data. It thus means in particular that the database has stored information about how good the object data are. It thus means in particular that information is stored about which sensor was used to record the object data. A poor sensor may, for example, be a sensor in a smartphone. A good sensor may, for example, be a sensor of a stereo camera.

The above-described embodiments relating to the sensor images are not to be limited only to sensor images of a video camera, but are generally applicable to other sensors. The above-described embodiments are generally applicable to any surroundings sensors which are able to carry out sensor-based detection of particular surroundings.

The sensor data corresponding to the detected object are preferably transmitted to the database so that it may preferably be updated correspondingly in an advantageous manner. In particular, if the transmitted sensor data have higher quality than the stored object data, an update is very meaningful. Higher quality may, for example, mean that the sensor data have been recorded with the aid of a better, in particular higher-resolution, sensor than the object data. In particular, it may be provided that an update of the additional data is carried out with the aid of the transmitted sensor data. For example, the stored additional data may include information indicating that the object is dirty and/or damaged. However, according to the sensor data, which are generally more up-to-date than the stored additional data, the object is not dirty or damaged. The database may now store this more up-to-date information about the corresponding object data. For example, the stored additional data may include information indicating that the object is clean and/or undamaged. However, according to the sensor data, the object is dirty or damaged. In this respect, the database may advantageously be updated.

In one additional specific embodiment, it may be provided that a first analysis, also referred to as a proximate analysis, is carried out in the sensor data according to the objects to be searched for. In particular, the entire image may be searched in the proximate analysis. For example, the objects may be traffic signs or in particular specifically speed limit traffic signs. Thus, using the “traffic sign-speed limit” example, rough analysis is carried out on the sensor image with the aid of the proximate analysis according to corresponding characteristic features of speed limit traffic signs, here, for example, a red ring. However, in this step, no detailed analysis has yet been carried out in order, for example, to identify that the possible traffic sign displays a permitted maximum speed of 70 km/h or 100 km/h.

This detailed analysis of the corresponding search area is carried out if, according to the present invention, it is possible to determine a corresponding search area, since, according to a database query, the object to be searched for is known and in particular when and/or preferably where the object to be searched for will appear in the sensor data. Furthermore, a corresponding detailed analysis may also be carried out if, according to the proximate analysis, the object has been found in the search area.

In another specific embodiment which is not shown, it may be provided that a corresponding search area may be one-dimensional, two-dimensional, or multidimensional.

In summary, the present invention thus in particular includes the idea of triggering an object detection analysis using known data from a database. It thus means in particular that the object detection is pre-parameterized. In particular, it is thus ascertained what the next object is and/or when the next object will come and/or where the next object will be located. In particular, it may be ascertained with the aid of a database query what the next object in the direction of travel will be, relative to an instantaneous vehicle position. In particular, with the aid of information indicating when the next object will come and in particular with the aid of information indicating where the next object will be located, a corresponding search area may be determined in the sensor data or the sensor images. In particular, object position data and/or route data and/or road data, for example, a road course, in particular a straight or curved course, and/or an instantaneous vehicle position and/or an instantaneous speed and/or a sensor recording frequency may be used here to compute when and where the object will appear in the sensor data. Other data may preferably be additionally integrated for the computation.

With the aid of the present invention, it is thus advantageously made possible to increase a detection rate considerably, since in particular pre-parameterization allows making maximum use of computing power and thus the knowledge about which object is encountered, when it is encountered, and where it is located. Furthermore, it is advantageously possible to reduce costs.

1-13. (canceled)

14. A device for detecting at least one object represented in a stream of sensor image data, the sensor image data representing a sequence of images of vehicle surroundings of a host vehicle detected by a surroundings sensor, comprising:
a first position determination unit for determining a vehicle position of the host vehicle;
an ascertainment unit for ascertaining, based on the determined vehicle position on a route of the host vehicle, which object is situated in the direction of travel of the host vehicle; and
a filter for filtering the sensor image data to reduce the amount of the sensor image data searched to detect the ascertained object in the sensor image data, by limiting a search for the ascertained object to a portion of the sensor image data corresponding to a location of the ascertained object in the images.

15. The device as recited in claim 14, wherein the ascertainment unit includes a querying unit for querying a database based on the determined vehicle position, wherein object data including associated position data corresponding to objects are stored in the database.

16. The device as recited in claim 15, wherein the querying unit is configured to transmit sensor image data corresponding to the detected object to the database.

17. The device as recited in claim 15, further comprising:
a time determination unit for determining a point in time at which the ascertained object is detectable with the aid of the surroundings sensor, the filter being configured to filter the sensor image data according to the determined point in time.

18. The device as recited in claim 15, further comprising:
a second position determination unit for determining a relative position of the ascertained object with respect to the surroundings sensor, wherein the filter is configured to filter the sensor image data according to the determined relative position.

19. A method for detecting at least one object represented in a stream of sensor image data, the sensor image data representing a sequence of images of vehicle surroundings of a host vehicle detected by a surroundings sensor, comprising:
determining, by a first position determination unit, a vehicle position of the host vehicle;
ascertaining, by an ascertainment unit, based on the determined vehicle position on a route of the host vehicle, which object is situated in the direction of travel of the host vehicle; and
filtering, by a filter unit, the sensor image data to reduce the amount of the sensor image data searched to detect the ascertained object in the sensor image data, by limiting a search for the ascertained object to a portion of the sensor image data corresponding to a location of the ascertained object in the images.

20. The method as recited in claim 19, wherein the step of ascertaining includes a query of a database based on the determined vehicle position, wherein object data including associated position data corresponding to objects are stored in the database.

21. The method as recited in claim 20, wherein sensor image data corresponding to the detected object are transmitted to the database.

22. The method as recited in claim 20, wherein a point in time is determined at which the ascertained object is detectable with the aid of the surroundings sensor, and the sensor image data are filtered according to the point in time.

23. The method as recited in 20, wherein a relative position of the ascertained object with respect to the surroundings sensor is determined, and the sensor image data are filtered according to the determined relative position.

24. A non-transitory computer-readable data storage medium storing a computer program having program codes which, when executed on a computer, performs a method for detecting at least one object represented in a stream of sensor image data, the sensor image data representing a sequence of images of vehicle surroundings of a host vehicle detected by a surroundings sensor, the method comprising:
determining, by a first position determination unit, a vehicle position of the host vehicle;
ascertaining, by an ascertainment unit, based on the determined vehicle position on a route of the host vehicle, which object is situated in the direction of travel of the host vehicle; and
filtering, by a filter unit, the sensor image data to reduce the amount of the sensor image data searched to detect the ascertained object in the sensor image data, by limiting a search for the ascertained object to a portion of the sensor image data corresponding to a location of the ascertained object in the images.
